(19) United States
(12) Patent Application Publication
(10) Pub. No.: US 2008/0027164 A1
(43) Pub. Date: Jan. 31, 2008

(54) Reduced Odor RTV Silicone

(75) Inventor: Hans E. Haas, Stow, OH (US)

Correspondence Address: GIFFORD, KRASS, SPRINKLE, ANDERSON et. al., 2701 TROY CENTER DRIVE, STE. 330, TROY, MI, 48007, US

(73) Assignee: ILLINOIS TOOL WORKS, INC., Glenview, IL (US)

(21) Appl. No.: 11/782,948

(22) Filed: Jul. 25, 2007

Related U.S. Application Data
(60) Provisional application No. 60/820,818, filed on Jul. 31, 2006.

(51) Int. Cl. C08F 283/12; C08K 3/04; C08K 3/10; C08K 3/34

(52) U.S. Cl. 524/425; 524/433; 524/436; 524/588; 525/478

(57) ABSTRACT

A curable silicone composition is provided that includes a carboxylic acid scavenging reactant with an amount sufficient to reduce an odor associated with silicone curing. The carboxylic acid scavenging reactant illustratively includes a carbodiimide in the form of a monocarbodiimide or a polycarbodiimide; an aziridine; and a combination thereof. The composition optionally includes adjuvant provided to modify the physical or cure properties of the cured silicone. In particular, the composition is readily compatible with the inclusion of calcium carbonate, the use of which would otherwise cause gassing and/or curing upon storage. The composition optionally includes a condensation catalyst in the form of an organometallic compound with the metal ions of titanium, aluminum, tin, calcium, and zinc being particularly well suited for the function of catalyzing condensation reactions. A process for reducing acid emission from a RTV cured silicone is provided by adding a carbodiimide, an aziridine, or a combination thereof to a premanufactured RTV silicone composition containing acetoxy-terminated polysiloxane. The process is optionally provided with contacting a substrate to which the RTV silicone composition will be applied in intermediate layer of a carbodiimide, an aziridine, or a combination thereof.

### RELATED APPLICATIONS

This application is a non-provisional application that claims priority benefit of U.S. Provisional Application Ser. No. 60/820,818 filed Jul. 31, 2006; the contents of which are hereby incorporated by reference.

### FIELD OF THE INVENTION

The present invention in general relates to RTV silicone and in particular, to an RTV silicone liberating reduced quantities of volatile acetic acid during cure.

### BACKGROUND OF THE INVENTION

Room temperature vulcanizable (RTV) silicone compositions are routinely used in industrial and consumer settings. While cured silicone is quite benign, the cure of an RTV silicone releases an appreciable quantity of organic acid. Typically, the organic acid is acetic acid. As a result, RTV silicone precursor dispensed into ambient atmosphere represents an eye and skin contact hazard. These hazards are magnified when silicone precursors are applied in a confined environment. Currently, the response to the irritation associated with volatile organic acid is to improve ventilation or exit the area of application. These efforts do not address inherent limitations of conventional RTV silicone chemistry.

Thus, there exists a need for an RTV silicone which produces a limited quantity of organic acid in the course of cure relative to a conventional RTV silicone. A worksite exposure to an irritating organic acid is thereby reduced, and even eliminated.

### SUMMARY OF THE INVENTION

A curable silicone composition is provided that includes a carboxylic acid scavenging reactant with an amount sufficient to reduce an odor associated with silicone curing. The carboxylic acid scavenging reactant illustratively includes a carbodiimide in the form of a monocarbodiimide or a polycarbodiimide; an aziridine; and a combination thereof. The composition optionally includes adjuvant provided to modify the physical or cure properties of the cured silicone. In particular, the composition is readily compatible with the inclusion of calcium carbonate, the use of which would otherwise cause gassing and/or curing upon storage. The composition optionally includes a condensation catalyst in the form of an organometallic compound with the metal ions of titanium, aluminum, tin, calcium, and zinc being particularly well suited for the function of catalyzing condensation reactions. A process for reducing acid emission from a RTV cured silicone is provided by adding a carbodiimide, an aziridine, or a combination thereof to a premanufactured RTV silicone composition containing acetoxy-terminated polysiloxane. The process is optionally provided with contacting a substrate to which the RTV silicone composition will be applied in intermediate layer of a carbodiimide, an aziridine, or a combination thereof.

### DESCRIPTION OF THE INVENTION

The present invention has utility as a room temperature vulcanizing silicone that reduces organic acid emission from a silicone upon cure. Acetic acid represents the most common organic acid cure byproduct. RTV silicones are used as caulks, sealants and adhesives. Through the compounding of a carbodiimide or aziridine into an inventive formulation, the acid reacts with the carbodiimide or aziridine to form stable compounds that are less volatile and irritating than the original organic acid. As used herein, acetic acid is described as the prototypical organic acid byproduct, yet it is appreciated that other organic acid byproducts are comparably neutralized according to the present invention.

A conventional one-part RTV silicone adhesive formed from a reactive polymer prepared by reacting a hydroxyl endblock polydimethylsiloxane with a large excess of methyltriacetoxysilane as characterized by reaction I.

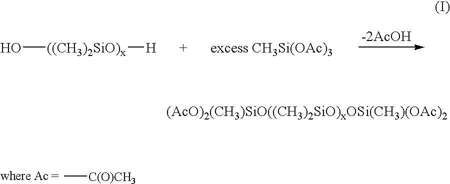

As part of this conventional formulation, with a large excess methyltriacetoxysilane used, the probability of two different hydroxyl endblock siloxane groups reacting with the same silane molecule is statistically improbable. As a result, acetoxy endblock polysiloxane reactive polymers are formed. The subscript “x” is chosen such that the resulting reactive polymer is a liquid, and amenable to packing in a sealed tube or cartridge. Upon exposing reactive polymer to ambient moisture, the acetoxy end groups are hydrolyzed to yield silanols which further condense this to link the polymer chains together. In the process, the acetoxy group is released in the form of acetic acid. It is appreciated that acetoxy functionality is also amenable to reacting with pendant hydroxyl groups extending from a siloxane polymer with the net result that condensation occurs in an intermediate situs, alone or in combination, with terminal condensation. According to one aspect of the present invention, a carbodiimide or aziridine is provided to react with acetic acid produced during silicone cure to form a stable N-acylurea or ester amine, respectively. As a result of neutralization of acetic acid according to the present invention, a user avoids exposure to a noxious and unpleasant byproduct. Additionally, as an inventive one-part RTV silicone composition is now rendered neutral, an inventive composition is amenable to application to acid-sensitive substrates, such as aluminum. Additionally, an inventive composition curing without emission of an acid product is amenable to inclusion of acid-sensitive fillers and other compounding elements.

A suitable hydroxyl containing polysiloxane operative herein preferably has at least two hydroxyl groups per polysiloxane. More preferably, polysiloxane has two terminal hydroxyl groups to facilitate end-to-end condensation cure. A polysiloxane operative herein is generally represented by the structure:

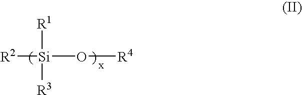

where R¹, R² and R³ are independently in each occurrence H, OH, C₁-C₈ alkyl, C₁-C₈ fluoroalkyl, C₆-C₁₂ cycloalkyls, C₆-C₁₂ fluorocycloalkyls, C₂-C₈ alkenyls, C₂-C₈ fluoroalkenyls, C₆-C₂₀ aryls, or C₆-C₂₀ fluoroaryls, and R⁴ is H, C₁-C₈ alkyl, C₁-C₈ fluoroalkyl C₆-C₁₂ cycloalkyls, C₆-C₁₂ fluorocycloalkyls, C₂-C₈ alkenyls, C₂-C₈ fluoroalkenyls, C₆-C₂₀ aryls, or C₆-C₂₀ fluoroaryls; with the proviso that at least hydroxyl moieties are present in the polysiloxane (II). As detailed above in the instance when only two hydroxyl groups are present, R² is OH and R⁴ is H. A fluorinated moiety includes one or more fluorine atoms substituted for an aliphatic hydrogen atom.

It is appreciated that the inclusion of more than three hydroxyl groups per polysiloxane (II) provides a measure of cross-linking to yield a structurally more rigid cured polysiloxane. As such, it is appreciated that inclusion of a lesser quantity of a siloxane having three or more hydroxyl moieties in a majority terminal dihydroxyl polysiloxanes provides an adjustable set of physical properties to the resultant polysiloxane based on the relative ratio thereof. When trihydroxy or higher hydroxy content polysiloxanes is present, it is typically added in amounts ranging from 0 to 5 hydroxy equivalents per hydroxy equivalents of dihydroxy polysiloxanes.

Preferably, R₁ and R₃ are H, alkyl or fluoroalkyl. Commercially available polysiloxanes are noted to typically include both R₁ and R₃ being methyl or fluoroalkyl R₁ being methyl while R₃ is H or phenyl.

It is appreciated that a blend of polysiloxanes bearing end moieties R₁—R₄ or x are readily used herein The value of “x” in the polysiloxane (II) is selected such that the polysiloxane viscosity is between 100 and 5,000,000 centipoise, so as to remain in a liquid or gelatinous state capable of packaging in sealed tubes and cartridges after reaction with an acetoxysilane (per reaction I).

The polysiloxane (II) is reacted with a silane to afford a reactive polymer. A silane operative herein generally has the formula:

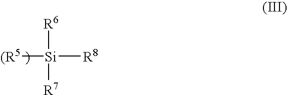

where R⁵, R⁶, R⁷ and R⁸ are independently in each occurrence (C₁-C₇)—C(O)—, H, C₁-C₈ alkyl, C₁-C₈ alkoxy, C₁-C₈ fluoroalkyl, C₆-C₁₂ cycloalkyls, C₆-C₁₂ fluorocycloalkyls, C₂-C₈ alkenyls, C₂-C₈ fluoroalkenyls, C₆-C₂₀ aryls, or C₆-C₂₀ fluoroaryls with the proviso that at least one of R⁵-R⁸ is (C₁-C₇)C(O) and the remaining substituents include no more than one H. Preferably C₁-C₇C(O) is CH₃C(O).

In order to form a one-part ambient moisture curable silicone, the reactant III has at least two (C₁-C₇)C(O) groups per molecule, such that one of such groups reacts with the polysiloxane form a (C₁-C₇)C(O) terminated polysiloxane. This is amenable to storage and upon reaction with atmospheric moisture, hydrolyzes to condense to the final cured silicone. More preferably, reactant III is a triacetoxysilane with the forth substituent also preferably being C₁-C₈ alkyl, C₁-C₈ alkoxy, or H. As depicted in equation I, the fourth reactant substituent in exemplary embodiment is methyl.

In an alternate embodiment, the reactant II having a single acetoxy moiety and at least one C₁-C₈ alkoxy moiety reacts to form an alkoxy terminated polysiloxane capable of condensation curing with a hydroxyl group containing polysiloxane upon mixing of the two components in a manner analogous with two-part hydroxyl and block polymer condensation curing with an alkoxysilane. A two-part curable system according to this aspect of this invention is depicted in equation IV. It is noted that a cure occurs without any atmospheric moisture with the release of alcohol as a reaction byproduct leading to shrinkage upon cure of between about 0.3 and 1% linear shrinkage.

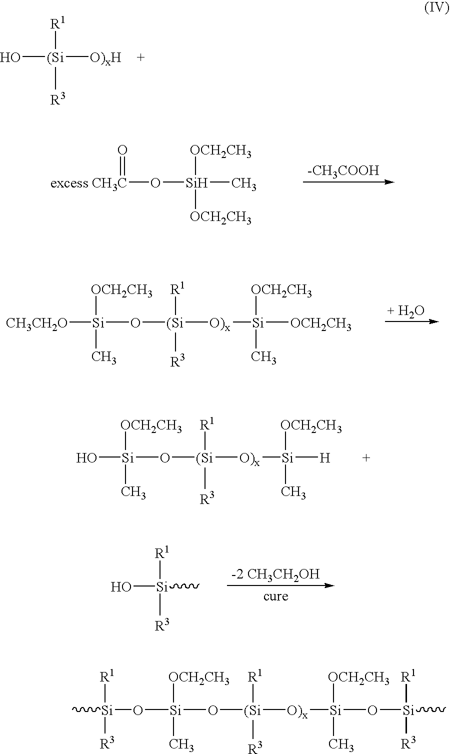

R¹, R² and R³ have the meanings described above with respect to polysiloxane II. The wavy line denotes a generic polymer backbone, denoting any polysiloxane or carbon to silicon bonded organic polymer. It is appreciated that the hydroxyl containing polysiloxane depicted in IV is readily formed in situ by the moisture induced hydrolysis of an acetoxy or alkoxy terminated polysiloxane or di-, tri- or tetraacetoxy silane or di-, tri-, or polyacetoxy containing polysiloxane.

Regardless of the reaction specifics, any silicone cure system that evolves an organic acid benefits from the inclusion of a carbodiimide or aziridine acid-neutralizing scavenger.

An acid-neutralizing scavenger operative herein includes carbodiimide or an aziridine. A carbodiimide operative herein includes a monodiimide of the formula:

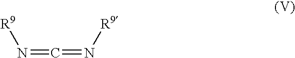

where R₉ and R9′ are independently in each occurrence C₁-C₈ alkyl, C₆-C₁₂ cycloalkyl or C₆-C₂₀ aryl. Preferably, R⁹ and R^{9′} are identical moieties. Specific exemplary monocarbodiimides include dicyclohexylcarbodiimide, diisopropylcarbodiimide, dimethylcarbodiimide, diisobutylcarbodiimide, dioctylcarbodiimide, t-butylisopropylcarbodiimide, diphenylcarbodiimide, di-t-butylcarbodiimide and di-β-naphthylcarbodiimide.

Additionally, polycarbodiimides are also operative herein. Polycarbodiimides are routinely formed by decarboxylation and condensation of organic phosphorous diisocyanate, as detailed in U.S. Pat. No. 2,941,956. Polycarbodiimides are commercially available from Nisshinbo (Tokyo, Japan) as various grades under the trade name Carbodilite.

The reaction of a carbodiimide with an organic acid yields an N-acyl urea. For the reaction of acetic acid with a monocarbodiimide, the acid-scavenging reaction proceeds as follows:

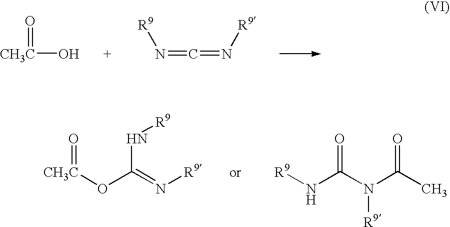

As the scavenging reaction of equation VI makes clear, one equivalent of carbodiimide is required for each equivalent of organic acid to be neutralized. As a result, the equivalence of carbodiimide and generated acetic acid are adjusted accordingly. Typically, for each equivalent of acetic acid generated, between 0.3 and 3 equivalence of carbodiimide are provided depending on the desired degree of acid neutralization and odor suppression desired. It is appreciated that one-part moisture curing silicones cure at the interface of contact with the exterior moisture source with cure proceeding inward over time. As a result, additional carbodiimide is optionally applied intermediate between a substrate and a one-part RTV silicone composition in order to address initial acetic acid evolution.

As an alternate or in combination with a carbodiimide, an aziridine is provided to also neutralize organic acid. The acid scavenging reaction of an aziridine according to the present invention with acetic acid is depicted in equation VII.

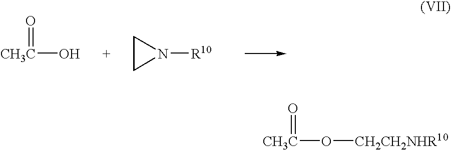

where R¹⁰ is H, C₁-C₂₄ alkyl, C₂-C₂₄ alkenyl, and C₆-C₂₄ aryl. Preferably, R₁₀ is C₁-C₂₄ alkyl.

It is appreciated that reaction of an organic acid with an aziridine under ambient atmosphere curing conditions of between 10° and 40° C. preceding within a matter of minutes for an aromatic acid may take several hours to react with acetic acid. As a result, aziridines are better suited for scavenging acetic acid generated during prolonged cure or throughout the cure process where acid byproduct is aromatic. As with carbodiimide, one equivalent of aziridine is required for each equivalent of acid evolved during cure. Typically, 0.3-3 equivalents of aziridine are provided for each equivalent of acids to be evolved depending on the kinetics and desired level of odor suppression and acid neutralization. Optionally, a substrate is provided with a coating of aziridine, alone or in combination with a carbodiimide prior to application of an acid-liberating cured silicone composition as to inhibit initial acid evolution corrosion of the substrate.

In addition to the above-detailed components associated with cure and acid neutralization, an inventive silicone composition optionally includes adjuvant provided to modify the physical or cure properties of the cured silicone. These adjuvants illustratively include fillers, adhesion promoters and cure catalysts. Fillers operative herein illustratively include silicone in various forms, diatomaceous earth, carbon black, and magnesium oxide, magnesium hydroxide, metal oxide particulates, silicates, and calcium carbonate combinations thereof. While conventional one-part RTV silicone evolving organic acid is incompatible with various carbonate fillers, since reaction with the organic acid and the carbonate involves carbon dioxide tends to foam the silicone composition during cure, or cause gassing and/or curing upon storage, a composition according to the present invention is readily formatted to include calcium carbonate or other carbonate fillers since acid neutralization is largely accomplished by reaction with carbodiimide or aziridine. Typical loadings of filler are from 0 to 300 parts per weight per 100 parts per weight of polysiloxane precursor.

An optional condensation catalyst is an organometallic compound. The metal ions of titanium, aluminum, tin, calcium, and zinc are particularly well suited for this function of catalyzing condensation reactions. Dialkyltin and zinc dicarboxylates are commercially the most popular catalysts to facilitate such reactions.

Exemplary classes of organometallic condensation catalysts are the dialkyldi(β-diketo)stannates, dialkyltin dicarboxylates, calcium and zinc dicarboxylates and butyltitanium chelate compounds. Specific tin catalysts illustratively include dibutyltin diacetate, dibutyltin dilaurate, and dibutyltin di(2-ethylhexanoate).

The condensation catalysts which may be used in the compositions according to the invention can be either a single type or a mixture of at least two types of such condensation catalysts. The compositions of the present invention contain the condensation catalyst in amounts preferably of 0 to 10 parts by weight, particularly preferably of 0.01 to 5 parts by weight and especially of 0.1 to 4 parts by weight, based in each case on 100 parts by weight of polysiloxane.

The present invention is further detailed with respect to the following non-limiting examples.

### EXAMPLES

100 parts per weight of Dow Corning DC732 black RTV one-part silicone composition is spread onto an unglazed ceramic substrate in an amount of 30 grams. The approximate composition of DC732 in an uncured state is as follows:

| | |
|---|---|
| Hydroxy-terminated polydimethylsiloxane | 80% |
| Trimethylsilyl terminated polydimethylsiloxane | 10% |
| Fumed silica | 5% |
| Ethyl/methyl triacetoxy silane blend | 4% |
| Pigments/catalysts/additives | 1% |

Two minutes after extrusion, the acetic acid odor is rated by smell based on a five point linear scale ranging from very strong to non-existent. The initial tack free time is noted, as well as tack free time after aging for six days at 82° C. and 12 days 82° C. The odor associated with a 12 day sample age at 82° C. before application is also noted on the five point scale. The Dow Corning 732 RTV silicone served as a control sample. In order to evaluate the ability of carbodiimides or aziridines to reduce acetic acid emission from a curing one-part RTV silicone, various quantities of DC732 silicone were combined with commercially available carbodiimides and aziridines amounted to yield a total of 100 parts by weight of material. As with the pure DC732 control, initial acetic acid odor is noted. The results for examples A-F and the conventional DC732 pure control are provided in Table 1.

TABLE 1
Acetic acid odor control from conventional one-part
RTV silicone through addition of carbodiimide or aziridine

| Component | Control | A | B | C | D | E | F |
|---|---|---|---|---|---|---|---|
| DC 732 Black (1) | 100 | 93.5 | 90 | 95.5 | 93.5 | 95 | 95 |
| Zoldine | — | 6.5 | 10 | — | — | — | — |
| XL-29SE (2) | | | | | | | |
| Stabilizer 2000 (3) | — | — | — | 4.5 | 6.5 | — | — |
| Stabilizer 7000 (4) | — | — | — | — | — | 5 | — |
| Xama 220 (6) | — | — | — | — | — | — | 5 |
| Initial acetic odor | very | mild | very | mild | very | mild | mild |
| | strong | | mild | | mild | | |

1) Dow Corning Corp.
2) Angus Chemical, eq wt = 820 as supplied (carbodiimide), 50% active liquid
3) Raschig, eq wt = 615 (carbodiimide), liquid
4) Raschig eq wt = 362 (carbodiimide), low melting powder
6) Bayer, eq wt = 167 (aziridine), liquid

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. A curable silicone composition comprising:
a silanol containing polysiloxane;
a silane containing at least one silicon bonded carboxylate group;
a carboxylic acid scavenging reactant selected from the group consisting of: a carbodiimide, an aziridine, and a combination thereof; said scavenging reactant present in an amount sufficient to reduce an odor associated with said carboxylic acid.

2. The composition of claim 1 further comprising a carbonate filler_selected from the group consisting of calcium carbonate, diatomaceous earth, carbon black, magnesium oxide, magnesium hydroxide, metal oxide particulate, and silicate.

3. The composition of claim 2 wherein said carbonate filler is up to 300 parts per weight every 100 parts per weight of said polysiloxane.

4. The composition of claim 1 further comprising a condensation catalyst selected from the group consisting of dialkyldi(β-diketo)stannate, dialkyltin dicarboxylate, calcium dicarboxylate, zinc dicarboxylate, butyltitanium chelate compound, dibutyltin diacetate, dibutyltin dilaurate, and dibutyltin di(2-ethylhexanoate).

5. The composition of claim 4 wherein said condensation catalyst is up to 10 parts by weight per 100 parts by weight of said polysiloxane.

6. The composition of claim 1 wherein said scavenging reactant is a carbodiimide of the formula: 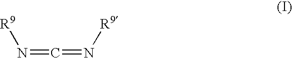
where R⁹ and R^{9′} are independently in each occurrence C₁-C₈ alkyl, C₆-C₁₂ cycloalkyl or C₆-C₂₀ aryl.

7. The composition of claim 1 wherein said scavenging reactant is a carbodiimide in the form of a polycarbodiimide.

8. The composition of claim 6 wherein said carbodiimide is 0.3 to 3 parts by weight per 1 part by weight of said carboxylic acid.

9. The composition of claim 1 wherein said scavenging reactant is an aziridine having the formula: 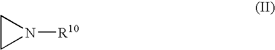
where R¹⁰ is H, C₁-C₂₄ alkyl, C₂-C₂₄ alkenyl, and C₆-C₂₄ aryl; and preferably, R¹⁰ is C₁-C₂₄ alkyl.

10. The composition of claim 9 wherein said aziridine is 0.3 to 3 parts by weight per 1 part by weight of said carboxylic acid.

11. The process for reducing carboxylic acid emission from a RTV curing silicone comprising:
adding a carbodiimide, an aziridine, or a combination thereof to a pre-cured RTV silicone composition containing acetoxy-terminated polysiloxane.

12. The process of claim 11 wherein said carbodiimide is 0.3 to 3 parts by weight per 1 part by weight of said carboxylic acid.

13. The process of claim 11 wherein said aziridine is 0.3 to 3 parts by weight per 1 part by weight of said carboxylic acid.

14. The process of claim 11 further comprising contacting a substrate to which said RTV curing silicone composition is applied in intermediate layer of a carbodiimide, an aziridine, or a combination thereof.
